(19) United States
(12) Patent Application Publication
(10) Pub. No.: US 2024/0070512 A1
(43) Pub. Date: Feb. 29, 2024

(54) QUANTUM COMPUTING SYSTEM AND METHOD

(71) Applicant: Odyssey Therapeutics UK Limited, London (GB)

(72) Inventors: Shuxiang Cao, London (GB); Hongxiang Chen, London (GB); Edward Grant, London (GB); Jules Tilly, London (GB)

(21) Appl. No.: 18/271,918

(22) PCT Filed: Jan. 14, 2022
(86) PCT No.: PCT/GB2022/050084

§ 371 Date: Jul. 12, 2023

(30) Foreign Application Priority Data
Jan. 14, 2021 (GB) 2100468.4

(51) Int. Cl. G06N 10/60; G06N 10/20

(52) U.S. Cl. CPC G06N 10/60; G06N 10/20

(57) ABSTRACT

A quantum computing system and method are disclosed. The system includes a modular architecture comprising a plurality of units, each unit having an input interface and an output interface and having a type selected from a set including a controller unit, a quantum processing unit and a classical processing unit. Each quantum processing unit is connectable to a quantum computing device and includes a data converter, the input interface being selectively connectable to other units of the modular architecture and configured to pass data received at the input interface to the data converter and pass the output of the data converter to the quantum computing device, the output interface being selectively connectable to other units of the modular architecture and configured to pass data received from the quantum computing device to the data converter and pass the output of the data converter to the output interface for communication to the units of the modular architecture connected to the output interface. Each classical processing unit is configured to execute a stateless arithmetic function on inputs received at its input interface and is configured to output the function's output at its output interface, each classical processing unit being configured to be executed by a non-quantum computing device. Each controller unit is configured to execute control logic associated with the architecture and is further configured to direct operation of the unit or units linked to its output interface.

### FIELD OF THE INVENTION

The present invention relates to a quantum computing system and method and, in particular, to an extensible architecture that supports deployment of different types of quantum computing systems.

### BACKGROUND TO THE INVENTION

Quantum computing is a disruptive paradigm that is widely believed to be capable of solving classically intractable problems. However, the route toward full-scale quantum computers is obstructed by immense challenges associated with the scalability of the platform, the connectivity of qubits, and the required fidelity of various components. That is not to say that quantum computing systems are not within reach. Near-term intermediate scale quantum (NISQ) devices already exist. A NISQ device is a specific kind of device with limited qubits (quantum bits) that can perform noisy quantum operations. Applications have been proposed for such early quantum computers, and have been called NISQ applications. The traditional way to test NISQ algorithms is by programming a classical simulator to run on a high-performance computer (completely isolated from a real quantum computer) or program simulator with device-specific mathematical models that implement these algorithms, then transferring it to real quantum devices (such as a NISQ Quantum processing stage, QPU).

The principal difference between NISQ devices and true quantum computing devices is speed and precision of handling qubits. The two device types can be used as direct substitutions. The applicable uses for quantum computing devices will increase as we approach commercially viable and affordable quantum computing devices.

### STATEMENT OF THE INVENTION

According to an aspect of the present invention, there is provided a quantum computing system having a modular architecture comprising a plurality of units, each unit having an input interface and an output interface and having a type selected from a set including a controller unit, a quantum processing unit and a classical processing unit, wherein:
each quantum processing unit is connectable to a quantum computing device and includes a data converter, the input interface being selectively connectable to other units of the modular architecture and configured to pass data received at the input interface to the data converter and pass the output of the data converter to the quantum computing device, the output interface being selectively connectable to other units of the modular architecture and configured to pass data received from the quantum computing device to the data converter and pass the output of the data converter to the output interface for communication to the units of the modular architecture connected to the output interface;
each classical processing unit is configured to execute a stateless arithmetic function on inputs received at its input interface and is configured to output the function's output at its output interface, each classical processing unit being configured to be executed by a non-quantum computing device;
each controller unit is configured to execute control logic associated with the architecture and is further configured to direct operation of the unit or units linked to its output interface.

The data converter may be configured to transform the data received via the quantum processing unit's input interface into instructions to manipulate the quantum computing device. The output interface of each classical processing unit may be configured to output to other units in the modular architecture or to a display or data storage system.

One or more of the controller units may be connected to a memory and is configured to save the current state of an algorithm implemented by the architecture in the memory. One or more of the units may be a classical unit configured to simulate a quantum computing device. One or more of the units may comprise a field programmable gate array, FPGA. The quantum computing device may be remote, such as connected via a network and not collocated with the quantum processing unit, the quantum processing unit being configured to execute instructions to control the quantum computing device.

The quantum computing system may further comprise a processor configured to execute computer program code to provide a user interface, the user interface being configured to provide an abstract representation of the modular architecture and being configured to receive user inputs to define or modify one or more selected from the set of:
number of units; type of a unit; configuration of a unit; connection to a unit's input interface; and, connections from a unit's output interface.

The quantum computing system may further comprise a platform provisioning and linking the respective units in accordance with the abstract representation.

The quantum computing system may further comprise a data repository defining architecture blocks, each architecture block comprising a plurality of pre-connected units, the user interface being configured to receive a user input selecting one of the architecture blocks and is configured to insert the pre-connected units corresponding to the architecture block into the abstract representation.

According to another aspect of the present invention, there is provided a quantum computing method comprising:
providing a plurality of units having types including a controller unit type, a quantum processing unit type and a classical processing unit type, each unit having an input interface and an output interface;
forming a quantum computing algorithm from instances of units having connections between selected ones of their respective input and output interfaces, each instance of a unit being of one of the unit types;
converting data received at an input of each quantum processing unit, executing a quantum computing device in accordance with the converted data, converting the output of the quantum computing device and outputting the converted output via the quantum processing units output interface;
in each classical processing unit, executing a stateless arithmetic function on inputs received at its input interface and outputting the function's output at its output interface;
executing the quantum computing algorithm by directing operation of the unit or units linked to the output interface of the or each unit having a controller unit type.

The step of converting data may include transforming the data received via the quantum processing unit's input interface into instructions to manipulate the quantum computing device.

The method may further comprise directing the output of the or each classical processing unit to a display or data storage system.

The method may further comprise connecting each controller unit to a memory and saving at least a portion of the current state of the algorithm in the memory.

The method may further comprise creating an instance of a unit by simulating it on a non-quantum computing device.

The method may further comprise creating an instance of a unit by programming a field programmable gate array, FPGA.

The method may further comprise providing a user interface providing an abstract representation of the algorithm including a representation of instances of the units and their connections and receiving user inputs to define or modify one or more selected from the set of:
number of units; type of a unit; configuration of a unit; connection to a unit's input interface; and, connections from a unit's output interface.

The method may further comprise the step of executing a platform provisioning and linking the respective units in accordance with the abstract representation.

The method may further comprise receiving, via the user interface, a user selection of an architecture block, retrieving from a data repository a definition of the selected architecture block, the definition including unit types and connections for a plurality of pre-connected units, and inserting the pre-connected units corresponding to the architecture block into the abstract representation.

According to another aspect of the present invention, there is provided a modular quantum computing system including:
a plurality of quantum processing units, each quantum processing unit including an input interface, an output interface and a data converter, the input interface being selectively connectable to other units of the quantum computing system and configured to pass data received at the input interface to the data converter and pass the output of the data converter to a quantum computing device, the output interface being selectively connectable to other units of the quantum computing system and configured to pass data received from the quantum computing device to the data converter and pass the output of the data converter to the output interface for communication to the unit or units connected to the output interface;
a plurality of classical processing units each classical processing unit including an input interface and an output interface and being configured to execute a stateless arithmetic function on inputs received at its input interface and is configured to output the function's output at its output interface, each classical processing unit being configured to be executed by a non-quantum computing device;
a controller unit connected to the input interface of one or more of the quantum processing units and/or one of the classical processing units and configured to execute control logic to direct operation of the unit or units connected thereto.

According to another aspect of the present invention, there is provided a computer program product, comprising a computer usable medium having a computer readable program code embodied therein for performing a quantum computing method, including:
computer readable program code configured to execute a plurality of quantum processing units, each quantum processing unit including an input interface, an output interface and a data converter, the input interface being selectively connectable to other units of the quantum computing system and configured to pass data received at the input interface to the data converter and pass the output of the data converter to a quantum computing device, the output interface being selectively connectable to other units of the quantum computing system and configured to pass data received from the quantum computing device to the data converter and pass the output of the data converter to the output interface for communication to the unit or units connected to the output interface;
computer readable program code configured to execute a plurality of classical processing units each classical processing unit including an input interface and an output interface and being configured to execute a stateless arithmetic function on inputs received at its input interface and is configured to output the function's output at its output interface, each classical processing unit being configured to be executed by a non-quantum computing device;
computer readable program code configured to execute a controller unit connected to the input interface of one or more of the quantum processing units and/or one of the classical processing units and configured to execute control logic to direct operation of the unit or units connected thereto.

According to another aspect of the present invention, there is provided a quantum computing method comprising:
receiving an algorithm definition, the algorithm definition comprising a plurality of classical processes and a plurality of quantum processes and defining a data flow therebetween;
generating a directed acyclic graph representation and associated control flow from the algorithm definition, whereby processes comprise nodes of the graph and data flow is defined by edges of the graph between nodes and the classical and quantum processes are stateless and executed independently and under the control of the control flow.

The quantum computing method may further comprise:
instantiating classical and quantum processing resources to execute the classical and quantum processes;
passing data to the instantiated resources to execute in accordance with the control flow;
receiving output from the executed instantiated resource; and,
updating a stored state of the algorithm using the received output.

The quantum computing system may comprise a variational quantum eigensolver, VQE, configured to determine the eigen energy of a molecule, the VQE comprising a controller unit, a quantum processing unit and a classical processing unit, wherein the system is configured to receive a Hamiltonian of a given molecule and an ansatz as input parameters to the control unit,
the quantum processing unit and a classical processing unit being configured to execute in an iterative loop under control of the control unit,
the quantum processing unit being configured to receive the ansatz and Hamiltonian from the control unit, determine a plurality of expectation values of the ansatz for the Hamiltonian, each with different parameters and output to the classical processing unit; the classical processing unit being configured to perform a gradient evaluation and value differences of the expectation values from the quantum processor and to determine and output the eigen energy of the given molecule. The controller unit may be configured to vary the ansatz for each iteration.

The quantum computing system may comprise a quantum phase estimator, QPE, configured to determine the eigen energy of a molecule, the QPE comprising a controller unit, a quantum processing unit and a classical processing unit,
wherein the system is configured to receive a Hamiltonian of a given molecule, the control unit being configured to determine stopping criteria and trigger the quantum processing unit and the classical processing unit to run,
the quantum processing unit being configured to determine an encoded ground state energy from the Hamiltonian and to project the encoded ground state energy onto an ancillary qubit register and output to the classical processing unit until the stopping criteria are met; the classical processing unit being configured to perform a statistical estimate of the certainty of the output from the quantum processor, and to determine and output the eigen energy of the given molecule.

One or each of the controller unit and the classical processing unit may be defined in a portable, computer readable and executable, definition and is moveable from one underlying classical hardware processor to another transparently to execution of the VQE or QPE.

The quantum processing unit may be defined in a portable, computer readable and executable, definition and moveable from one underlying quantum hardware processor to another transparently to execution of the VQE or QPE.

The quantum processing unit may be defined in a portable, computer readable and executable, definition and moveable from a simulated quantum processor to a hardware quantum processor or from a hardware quantum processor to a simulated quantum processor transparently to execution of the VQE or QPE.

It will be appreciated that the classical, quantum and controller units may be hardware, software or firmware based or some combination thereof. They may also be changed from one type to another—for example simulated in software and then moved to an FPGA or similar. This enables significant flexibility and adaptability that has not been previously possible. It also enables a new way of implementing quantum algorithms to be produced in which quantum and classical tasks are divided and handled by best placed or most readily available infrastructure. In some embodiments, a software wrapper may be used to interface the modular architecture with a hardware unit—for example this would allow QPU as a service type providers to be integrated into the architecture and for QPUs to be moved from one service provider to another without needing the service provider to natively support the architecture. In such an arrangement, the QPU itself would not be provided by the provider of the architecture, instead the quantum unit provides the interface to some remote QPU resource.

Preferably, the units are arranged in the form of a directed acyclic graph with the units comprising nodes of the graph and edges defining passage of data between the units.

Preferably, the classical processing units are configured to generate appropriate inputs to the next nodes downstream in the graph in dependence on outputs from nodes upstream in the graph.

The control node or nodes are preferably configured to control overall logic flow within the architecture and may vary in complexity from simple constructs such as for-type loops up to state machines or more complex control architectures. States to be passed to the quantum and classical processing units are determined by the controller units, which may operate with local memories or some global collective memory.

The principal difference between NISQ devices and true quantum computing devices is speed and precision of handling qubits. The applicable uses for quantum computing devices will increase as we approach commercially viable and affordable quantum computing devices.

The present invention seeks to provide a system and method that provides ease of implementation of quantum algorithms while transparently managing the underlying complexity of the implementation on real quantum devices.

Most current system architectures used to run algorithms on Quantum devices (or hybrid systems) do not distinguish perfectly between stateful control logic and stateless computation stages required to perform the algorithm. Embodiments of the present invention seek to provide a clear distinction between these concepts and modularity for developers to build algorithms that effectively and efficiently allocate tasks between quantum and classical hardware.

In embodiments of the present invention, quantum computing systems or algorithms made of quantum devices and classical devices are created and/or managed. Embodiments use a modular architecture comprising a plurality of units (stages) that can be of various implementation types including: hardware; software executed on a processor; a simulated classical or quantum device executed in software; or, a connector unit that bridges to an external/remote unit that itself can be of the various implementation types. Units also can each be changed for a different unit implementation type without impacting the overall system. Each unit has an input interface, an output interface and a type. There are two possible stateless units: quantum processing units and classical processing units. The controller unit enables implementation of stateful control logic.

Execution speed is an important consideration in QPU implementations. A preferred embodiment of the present invention is implemented in/integrated into the control electronics of a QPU. Such an arrangement provides significant advantages in that a firmware or an electronics-level implementation means that control logic flow and classical processing can be separated from quantum processing while, at the same time, executed on board the QPU hardware. Such an implementation enables minimal impact to execution speed while increasing flexibility and also ensuring quantum processing resources are used as efficiently as possible.

Quantum processing units preferably include functionality which may include a set of instructions to manage the hardware implementing quantum information processing. They apply to a quantum computing device (or a simulator) and include a data converter, an input interface and an output interface. The interfaces are being selectively connectable to other units of the modular architecture. The interfaces are configured as such:
Input interfaces receive data (e.g. from a classical data source) and passes it to the data converter which transforms the data into instructions to manipulate the quantum device. The data converter then outputs the instructions to the quantum computing device(s).
Output interfaces pass the data received from the quantum computing device to a data converter. The data converter transforms data received from the quantum device (which will in general be in the form of measurement statistics) into a set of instructions to be passed on to the next unit(s) of the modular architecture connected to the output interface.

Classical processing units preferably include functionality which may include a set of instructions to manage the hardware implementing classical information processing. They are connectable to or executed upon a non-quantum computing device and include an input interface and an output interface. They execute stateless arithmetic functions on inputs received. The interfaces are also selectively connectable to other units in the modular architecture. They are configured as such:
Input interfaces receive data for classical processing, either directly from the user, from the output interface of (one) other non-quantum processing units, or from the output interface of one or several quantum processing units. From this, the classical processing units use non-quantum hardware to process the data received and transmit it to its output interface.
Output interfaces are connected to other units in the modular architecture or to a display or storage system.

The controller unit(s) is/are configured to define the state and dataflow associated with the modular architecture. It is/they are configured to direct operations of different units. The controller unit(s) also save and preserve the current state of the algorithm implemented by the architecture. The state may be stored inside a place of control logic, and the place depends on the actual executing model. For example, with FPGA it can be an on-chip register, with cloud service it could be one or more database, for local simulator it may be one or more variables.

Preferably, the stateless part of the architecture is arranged in the form of a directed acyclic graph with the units being represented by the nodes of the graph and the passage of data between the units being represented by the edges between nodes. The stateful part of the architecture can be simplified and preferably contains no mathematical calculations. Based on this, embodiments of the present invention use classical processing units, quantum processing units and controller units as building blocks that can quickly and easily be implemented as software units or used as a diagram for Field-Programmable Gate Array (FPGA) compilation.

The classical processing units are configured to generate appropriate inputs for the next nodes downstream in the graph in dependence on outputs from nodes upstream in the graph. A classical processing unit implements a stateless algorithm. It may for example be a mathematical function that given the same input gives the same output.

The controller unit(s) is/are configured to control the overall logic flow within the modular architecture and may vary in complexity from simple constructs such as for-type loops up to state machines or more complex control architectures. States to be passed to the input interfaces of quantum and classical processing units are determined by the controller units, which may operate with local memories or some global collective memory. The controller unit may be a single unit that supervises the entire architecture, or it may be distributed between units in the architecture.

Embodiments of the present invention seek to provide a system and method for creating and maintaining a hardware-agnostic software architecture to implement quantum computation algorithms on quantum devices and, in particular, seeks to provide a platform supporting block-based classical and quantum processing units and controller units providing logic operations. The units, with support of the platform, enable simple design and implementation of hybrid or pure quantum algorithms. The units and their links can be defined in an abstract language and then either simulated for verification and/or compiled into hardware specific languages for execution on devices such as, but not limited to, Central Processing Units (CPUs), Graphical Processing Units (GPUs), or Field-Programmable Gate Arrays (FPGAs); and quantum devices (QPUs). The computing devices may also be hybrid devices, NISQ devices or other computing devices. It will be appreciated that different computing device types can be substituted as needed or as they become available without rewriting the quantum algorithm definition.

The present invention seeks to provide ease of implementation of quantum algorithms while transparently managing the underlying complexity of the implementation on real quantum devices.

Embodiments of the present invention enable a user to describe quantum algorithms for NISQ devices (or full quantum devices) and then generate efficient implementations on physical NISQ QPUs, universal QPUs and hybrid classical-QPUs/NISQ QPUs or QPUs simulators. Embodiments of the present invention are applicable to hybrid classical-NISQ QPUs, as NISQ applications are mostly hybrid, and require a large and regular amount of operations to be conducted by a classical processing unit.

Embodiments seek to abstract the key part of defining a hybrid quantum algorithm (or NISQ application), while isolating the implementation details from the algorithm definition.

In preferred embodiments, a user-friendly syntax (possibly implemented via a Graphical User Interface—GUI) allows the algorithm to be written in a clean, decoupled and easy to read way. The algorithm is then compiled into a Directed acyclic graph (DAG), allowing further modification on compiled algorithms. The DAG is preferably editable via the GUI. It will be appreciated that as each unit has input and outputs, connectivity and underlying functionality of the algorithm implemented by the architecture can be easily and simply changed using drag and drop in the GUI. Even when implemented in hardware/firmware such as FPGAs, the changes in the GUI merely reflect where inputs and outputs are sent and therefore do not require changes to hardware (other than provisioning changes should more or less hardware units be needed). It will also be appreciated that the GUI may be provided with a library or similar resource defining common unit configurations to save the user having to specify common architectures or architecture blocks—these can be dragged into place and then customised as needed or connected to other similar library blocks (this could also be done in code as well as via the GUI).

Methods of the present invention described here are fully compatible with implementation on a simulator or a real quantum device. It makes abstraction of NISQ quantum algorithm be easily implemented on real quantum computer devices, by compiling to corresponding FPGA IP modules.

Embodiments of the present invention may include:
User friendly syntax based on common programming languages such as Python
Abstraction categories including “Quantum stage” (operations of the DAG to be conducted on a local or remote QPU interfaced by a quantum processing unit), “Classical stage” (operations of the DAG to be operated on any classical processing units) and “Control logic” (feedback operation between different units in the DAG).
The DAG definition for hybrid algorithms and its related creation methods
The method to compile existing DAG definition into implementations for various backends including different classical simulators and different physical QPUs.

Embodiments of the present invention enable efficient representation, creation and management of quantum and hybrid architectures for executing quantum algorithms on near-term quantum devices e.g. variational algorithms, and its corresponding package syntax and implementation. In some embodiments, the architecture is represented by a graph, which denotes the parts of the algorithm to be executed on quantum computer and classical computer as different nodes. In contrast to the normal way near-term quantum algorithms are represented, this method gives a more intuitive, backend neutral representation and provides a user-friendly syntax to construct near-term quantum algorithms. With this design, the algorithm can be directly compiled to a FPGA module and can communicate with quantum controlling instrument directly. It also allows the capability to implement parallel execution of the quantum algorithm. Architectures can be executed by single computing devices, cloud-based systems and/or distributed computing architectures.

One embodiment that uses the quantum computing system is a variational quantum eigensolver configured to determine the eigen energy of a molecule. Quantum simulation of quantum chemistry is of particular importance in areas including pharmaceuticals, materials science, biochemistry, and condensed matter physics. Here, a variational quantum eigensolver can be used to calculate the molecular ground energies and electronic structures using quantum gradient descent. Compared to existing methods, embodiments enable the VQE to be defined in a portable and flexible manner that can be independent of underlying hardware—classical processing is handled by a classical processing unit that can be moved from different hardware or even different service providers (such as cloud providers) while the quantum processing is too independent and portable and moveable from a simulation to hardware quantum processor or from one quantum processor type to another, all transparently to the VQE itself. Such embodiments provide flexible, efficient and powerful tools to solve quantum chemistry problems.

### BRIEF DESCRIPTION OF THE DRAWINGS

Embodiments of the present invention will now be described, by way of example only, with reference to the accompanying drawings in which:

FIG. 1 is a schematic diagram of a quantum computing system according to an embodiment;

FIG. 2 illustrates the modularity of the system in more detail;

FIG. 3 is a flow diagram of an embodiment, illustrating the generation of an architecture representation that is then used to implement quantum computing system;

FIG. 4 is an example simplified architecture representing a general variational eigensolver;

FIG. 5 is an illustration showing how distributed computing systems can be utilised; and

FIGS. 6-10 are illustrations showing how the modular architecture lends itself to simple implementation either in a simulated environment or in FPGA or similar devices.

### DETAILED DESCRIPTION

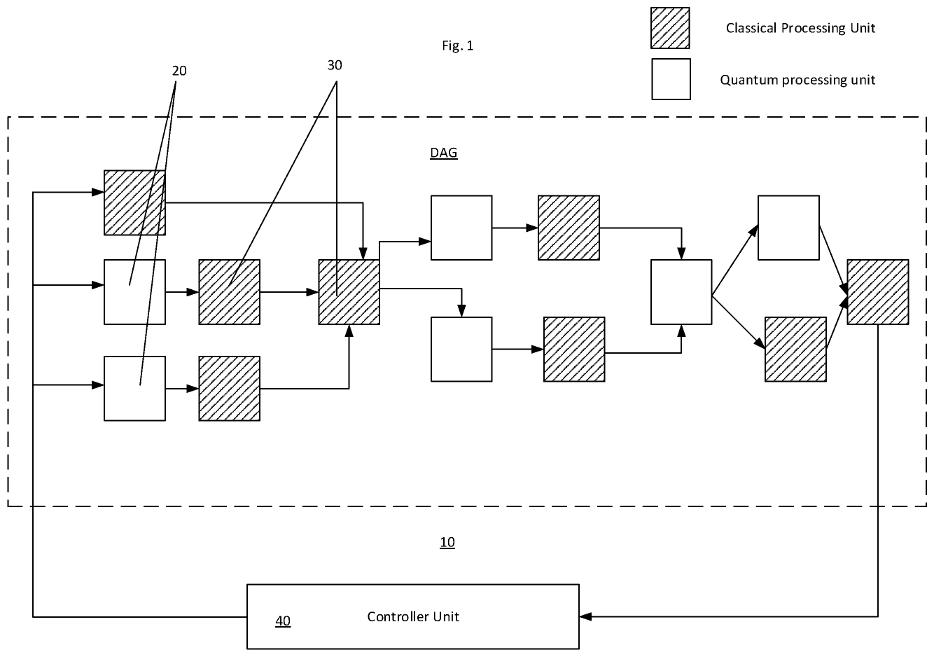

FIG. 1 is a schematic diagram of a quantum computing system according to an embodiment. The quantum computing system 10 has a modular architecture and comprises a plurality of units 20-40 each unit having an input interface and an output interface and having a type selected from controller unit 40, a quantum processing unit and classical processing unit 30.

Each quantum processing unit 20 is, or is connectable to, a quantum computing device. It includes a data converter, the input interface being selectively connectable to other units of the modular architecture and configured to pass data received at the input interface to the data converter and pass the output of the data converter to the quantum computing device. The output interface is selectively connectable to other units of the modular architecture and configured to pass data received from the quantum computing device to the data converter and pass the output of the data converter to the output interface for communication to the units of the modular architecture connected to the output interface.

Each quantum processing unit may be, simulate or be connected to a NISQ QPU or similar. As they become more commercially viable, the QPU may be a full quantum processor, a simulated QPU, etc. Example QPU architectures that may be connected to, used or simulated include superconducting qubit, trapped ion, photonic and rydberg atom.

Each classical processing unit 30 is a non-quantum processing system and is configured to execute a stateless arithmetic function on inputs received at its input interface and output the function's output at its output interface. The classical processing unit being configured to be executed by a non-quantum computing device such as a general purpose CPU.

When simulated, classical and quantum processing units may optionally be executed on the same computing device, although at implementation-time different configurations of computing devices or different FPGAs may be used. It will be appreciated that the modular architecture supports distributed computing and may be spread over different computing devices, locations, services or organisations. Additionally, different units can be moved locations or substituted for other units without impacting the overall architecture/algorithm.

The controller unit(s) 40 control logic flow. As the classical and quantum processing units are stateless, they are directed by the controller unit(s) 40. Units are called upon by the controller unit(s) 40 in a sequence (such as that set out in the DAG discussed below) to achieve the desired logic flow. For example, a calculation in a classical processing unit can be blocked by a controller unit 40 until all units on which the classical processing unit is dependent have returned their results.

Where the DAG includes branches, during execution the controller unit(s) 40 uses the state of the system to decide which branch to execute. The state itself would not be passed to downstream classical or quantum processing units, but the controller unit(s) would use it to decide what input data to present to the input interface or the units to be executed and whether the unit will be executed.

If the algorithm to be implemented is entirely state-free, optionally no controller unit 40 may be needed. In this situation, data flow to the next unit is included in the definition of each node of the DAG.

For software/cloud implementation, a classical processing unit may be a routine that executes a function when it receives input data, and returns the result. The quantum processing unit may be a routine that provides an interface to the backend QPU, asks the backend to execute the quantum algorithm and return the result. A software implemented controller unit is configured to update the state of the system based on results returned from classical and quantum processing units (and potentially external inputs such as user inputs) and calls classical/quantum processing unit based on its state.

For hardware/FPGA implementation, a classical processing unit may be a combinational circuit that processes input data classically. The quantum processing unit may be a firmware, FPGA or electronic circuit that performs functions corresponding to those of the software quantum processing unit above. The controller unit may be a sequential logic digital circuit that rewires the data flow depending on its state.

It will be appreciated that software and hardware implementations are not mutually exclusive and may be mixed or both used in some embodiments.

The input and output interface of each unit will be dependent on implementation. For example, it may be an application programming interface or it may be a series of wires on which inputs or outputs are presented.

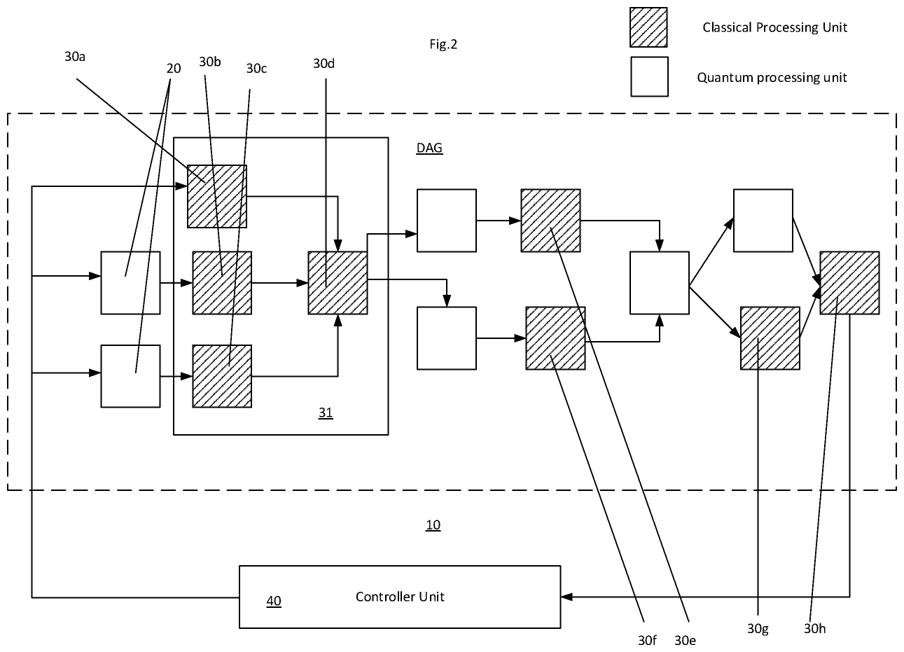

FIG. 2 illustrates the modularity of the system in more detail. In this example, the implementation type of the units of FIG. 1 are specified.

In the embodiment of FIG. 2a, selected ones (30a-30d) of the classical processing units are implemented in an FPGA 31 whilst others (30e-30h) are implemented in software and executed on a processor of a general-purpose computer. In this embodiment, all of the quantum processing units 20 are connected to a remote superconducting qubit architecture QPU 21. The controller unit 40 is also executed on the processor of the general purpose computer in this embodiment.

It will be appreciated that the modularity allows this to be easily changed at any time. For example, selected classical processing units could be moved to a cloud processing system. Similarly, the quantum processing units could be connected to a different type of QPU, for example trapped ion architecture.

As will be explained below, due to the modularity of the system and each unit having the same high level architecture (an input and output interface that can receive and operate on the same data, irrespective of whether the unit is hardware, software or simulated), units can be substituted without impacting the functionality of the overall system. Where unit implementations have different requirements (for example, different QPU architectures may need different instructions or data passed to them), this is handled and bridged internally to the respective unit and is transparent to the overall system.

Preferably, both the quantum and classical computing units are stateless. That is, they do not retain their states after execution.

The controller unit (although there may be more than one) is responsible for control logic associated with the architecture and being configured to direct operation of the unit or units linked to its output interface. For example, the controller unit may retain previous execution results and feed updated parameters back into the quantum and classical processing units.

Embodiments may be used, for example, to perform computationally heavy tasks such as calculating the energy of a given molecule based on the expectation value of the quantum ansatz, or working out nonlinear cost function of a quantum machine learning model.

The quantum processing units execute quantum circuits. Quantum circuits can be a parametrized ansatz for different purposes, or a given customized quantum circuits for special purposes such as gradient evaluation.

An example algorithm implemented by an embodiment of the present invention may execute a variational quantum eigensolver (VQE) algorithm. A fundamental task of quantum chemistry is to solve the eigenvalue problem of the molecular Hamiltonian. The eigenstates of the many-body Hamiltonian determine the dynamics of the electrons as well as the properties of the molecule. This is used in identifying candidate molecules for pharmaceuticals, for example. In one embodiment, a VQE algorithm is implemented using one or more quantum processing units, one or more classical processing units and one or more control units. It receives the Hamiltonian of given molecule, the ansatz (including the name of the ansatz model, the configuration parameters of the ansatz such as how many qubits and how deep it is, or a customized ansatz described with code) and the optimization method to be used (including the name of the optimization method, the parameters of the optimization method such as learn rate, maximum iteration, or a customized ansatz described with code) as input parameters and outputs the eigen energy of the given molecule.

Another example algorithm implemented by an embodiment of the present invention is a quantum phase estimator, QPE, configured to determine the eigen energy of a molecule. The QPE may comprise a controller unit, a quantum processing unit and a classical processing unit. The system is configured to receive a Hamiltonian of a given molecule and the control unit determines stopping criteria and trigger the quantum processing unit and the classical processing unit to run. The quantum processing unit is configured to determine an encoded ground state energy from the Hamiltonian, projects the encoded ground state energy onto an ancillary qubit register and outputs to the classical processing unit. The classical processing unit performs a statistical estimate of the certainty of the output from the quantum processor, and determines and outputs the eigen energy of the given molecule.

An approximation of the ground state is preferably used as an input, it can be calculated in any way we want (for example, using VQE), but the approximation must be ‘closer’ to the true ground state than any other eigenstate of the Hamiltonian. This ground state approximation is a quantum state (i.e. like in the case of the VQE), it is a state of the qubit register, information about the electronic wavefunction encoded into qubits along a basis (for example a spin orbital basis—each qubit represents the occupation of a spin orbital in the electronic wavefunction)

The aim of QPE is to compute the (near) exact ground state energy (a scalar), from an approximation of the ground state (a quantum state). The output of the quantum processing unit is preferably an encoding of the ground state energy on an ancillary qubit register: i.e. the ground state energy can be recovered and computed from measurement of this ancillary register. For instance (this is the most common example) the measurement of the ancillary register produces a binary string from which a decimal number can be computed, which can in turn be used to compute the ground state energy by the classical processing unit (as exactly as the binary encoding allows, i.e. if we have 10 qubits, that means we can recover 10 bits of information)

The probability of the ancillary register actually producing the true ground state energy is proportional to how close the approximation of the ground state used as the input is from the true determined ground state. Therefore, one cannot be sure that the output of QPE is the true ground state energy from one run of the process (actually, you can never be sure, but close enough if you have a good approximation of the ground state). Generally, the processing by the quantum processing unit is repeated a number of times and can use any statistical test to determine convergence (the stopping criteria). E.g., run QPE 10 times time and get number A 8 times and B 2 times, B happens to be higher than A, hence we know A is the probably the eigenvalue of the eigenstate closest to the ground state approximation. If however we obtain a number C once, which is lower than A, than C is a lower energy eigenvalue than A, and as such our approximation of the ground state is not good enough—C could be the ground state energy but no way to confirm. In contrast to the VQE, however, no iterative loop is needed by the QPE.

VQE is a variational algorithm (also known as a quantum-classical hybrid algorithm). The quantum operations required to produce the output are updated iteratively following the process defined by the control unit. QPE is not a variational algorithm—most of the computation is done on the quantum processing unit (it requires a lot more qubits, and a lot more quantum operations, which makes it impossible to implement on current machines). The classical processing unit is present to prepare the input, and decode the output and only executes once. The control unit is used to determine stopping criteria. The quantum operations remain unchanged throughout the algorithm

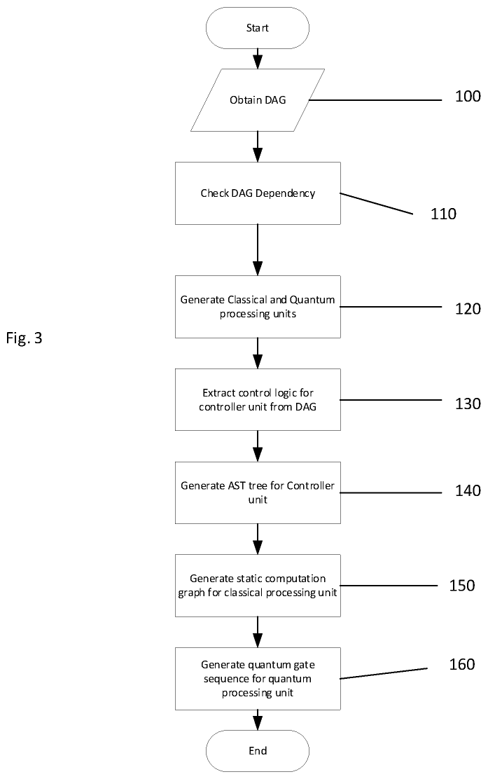

FIG. 3 is a flow diagram of an embodiment, illustrating the generation of an architecture representation that is then used to implement quantum computing system.

In this embodiment, a DAG defining an architecture representation is loaded from a file or created in step 100 (for example using a graphical user interface or compiled or interpreted from source code). Each node in the DAG corresponds to a classical or quantum processing unit and links show flow of data. In one embodiment, nodes (units) are implemented by a python class or a decorated function. The user can simply write the code by calling each class as a normal function or linking nodes in a GUI. The system preferably is configured in step 110 to check the dependency of specified units defined in the DAG (or in code) and then generate corresponding classical and quantum units in step 120. Generation here may comprise creation of an instance, preparation of executable code or selection and configuration of an appropriate pre-existing unit. A data repository or similar may be accessed to obtain data defining existing units, and their configuration/capabilities.

To address dependencies, deadlock and such issues, the process generating the DAG preferably checks for such issues and outputs an exception if one is detected. For example, during production of the DAG, for each decorated function it may return a placeholder denoting the output and register the input but would not execute the function. When the last output placeholder has been asked to compile, the compiler tracks trough the chain and convert it into a DAG.

It will be appreciated that the DAG is an intermediate representation that is used to generate and call units that in turn deal with lower level (and potentially hardware/QPU specific) functionality.

In step 130, control logic for the controller unit is extracted from the DAG by tracking the input parameter of each processing unit function and the return value of each processing unit function, as well as analyzing the abstract syntax tree of the host programming language. The allocated variables and returned values are preferably tagged with extra metadata to identify where it comes from. When it was used in a function call, the data flow can be identified and established. The system enables complex control logics, such as loops to be identified by analyzing the abstract syntax tree. Control logic such as a finite state machine can be generated for execution by the controller unit.

In steps 140, 150 and 160, internal representations are created. In step 140, the control logic for the controller unit is transformed into an AST tree. In step 150, each classical processing unit is used to generate a static computation graph and in step 160 each quantum processing unit is used to generate a quantum gate sequence. These are stored or retained in memory as intermediate representations.

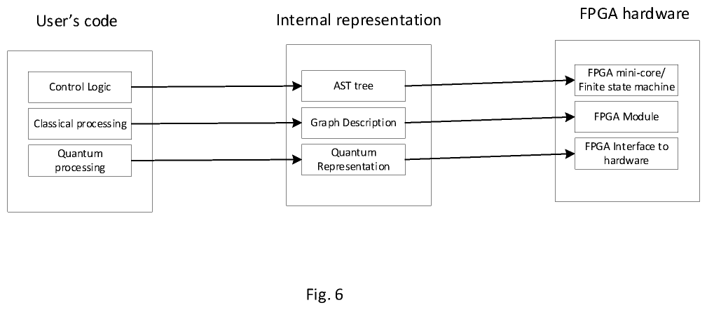

Once the intermediate representations of the quantum processing units, classical processing units and controller unit(s) have been generated, they can be instantiated and executed as discussed in grated detail in FIGS. 6-10.

For VQE, for example, the architecture may be defined in the form of an iteration loop. Such a loop is stateful and so is managed by a controller unit. Each iteration updates the ansatz angle parameter, and parameters are shared between different iterations. Ansatz angle parameters are a part of the control logic managed by the controller unit. To update the parameter, the value to change the parameters is determined using a classical unit with the gradient as the input. The gradient can also be evaluated by taking the output of several expectation values of the ansatz with different parameters. The calculation of these different ansatz measurement expectation value is performed by quantum processing units, and the gradient evaluation and value differences can be put into the same classical processing unit or separate classical processing units.

After constructing the architecture representation, it can be sent to a backend system (or multiple remote or local systems) to be executed. As an example, to execute on a local single quantum machine with FPGA scenario, the initial state of controller unit is reset, and the ansatz parameter is set to its initial value. By following the DAG diagram, FPGA interact with the quantum hardware interface to execute the quantum ansatz. After getting the expectation values of the ansatz, the system feeds these values into a classical processing unit. The classical processing unit will return the calculated new parameter value, and then controller unit changes the parameter value. The next iteration is then performed. When all iterations are finished or some other completion metric is met (such as processing time, reaching steady state, minimising error etc), the algorithm returns the solved molecule energy.

Preferred embodiments of the present invention provide convenient syntax to construct NISQ (and Quantum) algorithms, concrete intermediate representation, and straight forward interfaces to implement various backends, including simulators and different devices (classical and/or quantum).

The syntax is designed to allow users to define functions that can be treated as quantum processing units (to be executed on a QPU) or classical processing units (to be executed on a classical processing unit). A function call and its return value indicates the dataflow between each node of the DAG (quantum processing units or classical processing units are instances of DAG nodes). Together with loops and if-else clause, they are considered as control logic.

In the python programming language, the syntax for defining “Classical processing unit” and “Quantum processing unit” can be implemented with python decorators. A specific decorator class is created, which accepts run-time irrelevant parameters. These parameters are generally used as classical constants, iteration counters or to specify the shape of the quantum variational ansatz circuit. Extra run-time related parameters can be appended to the tag, which is useful to instruct the backend to do specific optimizations or execution procedures.

For example, for a VQE algorithm, we define a quantum processing unit. The ansatz we choose can be considered a run-time irrelevant parameter, since it won't change during the run time. However, the parameters (angles) of the ansatz, which will change every iteration during the run time, is a runtime parameter.

The intermediate representation describes a full quantum algorithm. It is a graph, which each node represents an instance of a quantum processing unit or a classical processing unit. The relationship between each unit as well as the outputs of the algorithm are stored in the DAG. It is similar to an abstract syntax tree but describes an algorithm at a higher level. FIG. 1 shows a general scheme of an internal representation. It includes classical processing units and quantum processing units, as well as the control logics described by the directed edge between two nodes.

An advantage of this internal representation is it describes the complete feedback loop of the algorithm, including different quantum processing units, classical processing units including the state updates. This is different from the general approach using similar DAG graph to represent the calculation dependency of the specific function latter used to calculate its gradients.

This graph-like intermediate representation allows users to manipulate the structure while executing the code. Users can define functions to manipulate graphs. Such as generating a new graph based on the output of the referenced graph, or generating an optimized graph which gives identical result as the referenced graph.

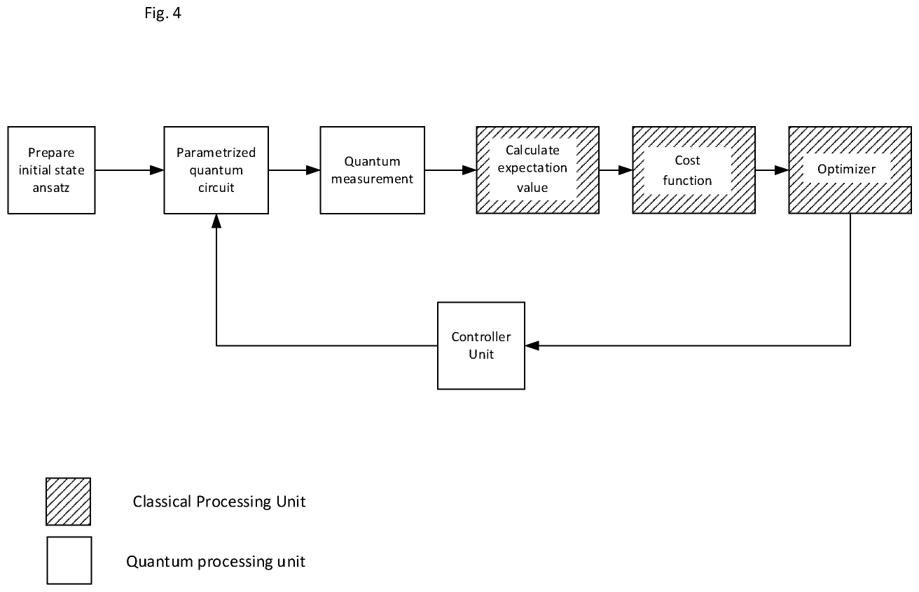

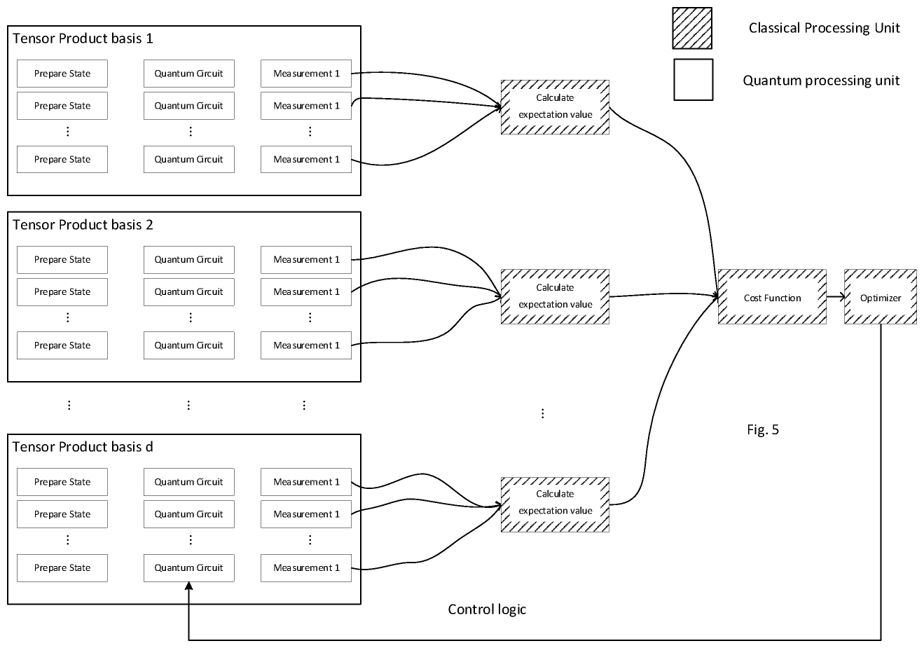

Intermediate representation enables the capability for distributed computing. As shown in FIG. 4, the representation describes the complete dependency between each unit, which allows independent units to be executed on different hardware or software simultaneously. Also, the internal representation has the full description of a quantum processing unit, which generally requires repeated sampling. This allows the sampling procedure being distributed on several different quantum hardware. FIG. 5 illustrates how the system can be executed in a distributed manner.

Intermediate representation provides the ability to compile classical processing units to FPGA code. Different classical processing units in an internal representation can be naturally considered as a digital circuit while different quantum processing units can be directly forwarded to FPGA-controlled pulse generation module. This allows a part of, or the whole, algorithm to be executed on the FPGA device, which is generally required for high-speed quantum feedback control. The control logic is compiled to a mini-CPU Core on FPGA, which execute an extended instruction set of RISC-V, an open source CPU architecture. The extended instruction set allows the mini-CPU core to interact with pre-synthesised modules to achieve the best performance.

Optionally, different backend interfaces may be provided. One example is a “hosted implementation”. The package can handle the execution of both control logic and classical processing unit, or control logic only, and offload the classical processing unit and quantum processing unit to the backend. The backend only needs to return a callable object that gives the result of the processing units. This process is called “stage compile”.

Another method of implementing backend is called “independent implementation”. It contains a function which accepts the entire internal representation as input and gives a callable object which returns the output of the entire algorithm.

In one embodiment, the entire architecture is defined in python and its performance is then tested on both simulators and actual quantum backends. The tested benchmarks include variational quantum eigensolver and hierarchical quantum classifiers. State-of-art training techniques were implemented as an optimizer that directly modifies internal representations.

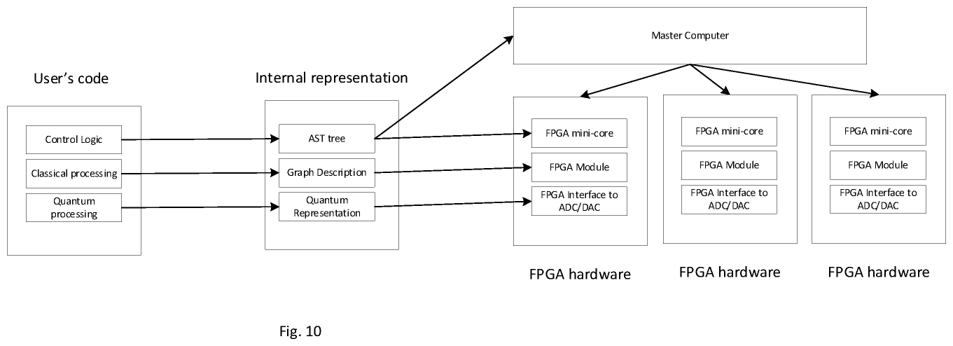

Embodiments of the present invention, due to the modular architecture lend themselves to simple execution either in a simulated environment or in FPGA or similar devices. This is illustrated in FIGS. 65-10. In these Figures, different example implementations are shown. In each case, the generation follows the operation in FIG. 3, starting with definition in code or in a GUI 200 that is translated into an internal representation 210. However, FIGS. 6-10 differ in how that internal representation is then instantiated.

In FIG. 6 the internal representations are transformed into FPGA based instances 220a that either execute the respective unit (control and classical processing unit) or act as an interface to a QPU. In this example (which may be used in a research lab, for example), the controller unit AST tree is compiled as a FPGA mini-CPU-core binary code or finite state machine (FSM), the classical processing unit graph description is compiled into a stateless FPGA module and the quantum processing unit is implemented as an FPGA module that communicates with the QPU's input (which may itself be an FPGA module).

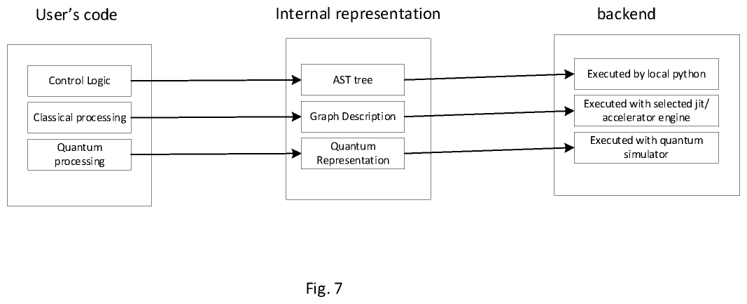

In FIG. 7 the internal representations are executed by a processor 220b (control and classical processing unit) while the quantum processing unit is executed within a QPU simulator 220c. In this example (generally suitable for research lab or small scale industry evaluation), the controller unit's AST tree is executed by a local python interpreter, each classical processing unit is compiled into a high-performance classical module, such as numba/pycuda/tensorflow etc and each quantum processing unit is connected to a quantum simulator backend.

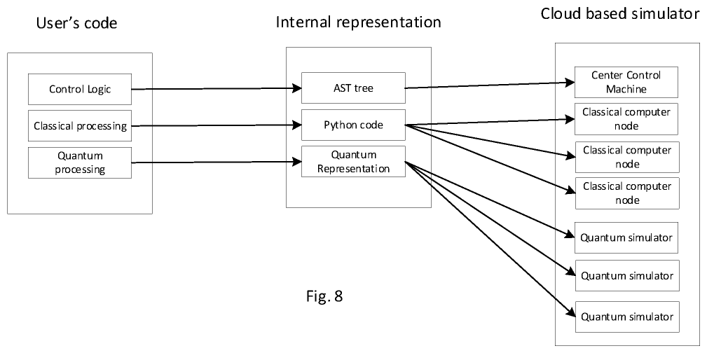

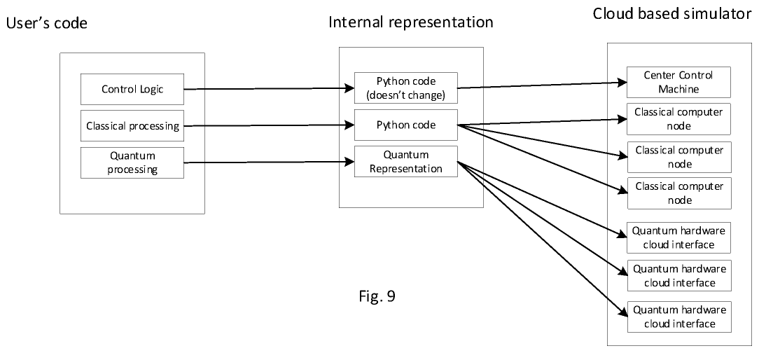

In FIGS. 8 and 9 the internal representations are on remote (in this case cloud based) resources 220d. In FIG. 8, a remote quantum simulator is used whereas in FIG. 9, a remote interface to remote quantum hardware acts as the quantum processing unit 220e.

In FIGS. 8 and 9, the controller unit's AST tree is executed on a master computer system which holds the state of the current algorithm and controls flow by unrolling the sampling/iteration (breaking parallelizable serial code into parallel pieces). It uses an asynchonization method that waits for a quantum/classical processing unit to finish and then triggers execution of another quantum/classical processing unit based on the returned value. The classical processing units are compiled into a high-performance classical module, such as numba/pycuda/tensorflow etc and then distributed to a processing cluster. Outputs are returned to the master center computer system.

In FIG. 8, the quantum processing units are connected to multiple different quantum simulator backends, each returning output data to the master computer system.

In FIG. 9, the quantum processing units are connected to multiple different hardware quantum processor backend interface such as qiskit or cirq, each returning output data to the master computer system.

In FIG. 10, the internal representations are transformed into FPGA cluster based instances 220f but other than executing in FPGA instead of remote cloud operate in a manner similar to the example of FIG. 9.

It will be appreciated that the data may be stored in various forms of repository including a central or distributed file store, database (such as SQL or other relational or non-relational database types). It may be implemented using storage devices such as hard disks, random access memories, solid state disks or any other forms of storage media. It will also be appreciated that the processor discussed herein may represent a single processor or a collection of processors acting in a synchronised, semi-synchronised or asynchronous manner.

It is to be appreciated that certain embodiments of the invention as discussed above may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

This application claims priority from GB 2100468.4, the content of which, including the content of the abstract filed herewith is incorporated herein by reference.

1. A quantum computing system having a modular architecture comprising a plurality of units, each unit having an input interface and an output interface and having a type selected from a set including a controller unit, a quantum processing unit and a classical processing unit, wherein:
each quantum processing unit is connectable to a quantum computing device and includes a data converter, the input interface being selectively connectable to other units of the modular architecture and configured to pass data received at the input interface to the data converter and pass the output of the data converter to the quantum computing device, the output interface being selectively connectable to other units of the modular architecture and configured to pass data received from the quantum computing device to the data converter and pass the output of the data converter to the output interface for communication to the units of the modular architecture connected to the output interface;
each classical processing unit is configured to execute a stateless arithmetic function on inputs received at its input interface and is configured to output the function's output at its output interface, each classical processing unit being configured to be executed by a non-quantum computing device;
each controller unit is configured to execute control logic associated with the architecture and is further configured to direct operation of the unit or units linked to its output interface.

2. The quantum computing system of claim 1, wherein the data converter is configured to transform the data received via the quantum processing unit's input interface into instructions to manipulate the quantum computing device.

3. The quantum computing system of claim 1 or 2, wherein the output interface of each classical processing unit is configured to output to other units in the modular architecture or to a display or data storage system.

4. The quantum computing system of claim 1, 2 or 3 wherein each controller unit is connected to a memory and is configured to save the current state of an algorithm implemented by the architecture in the memory.

5. The quantum computing system of any preceding claim, wherein one or more of the units is a classical unit configured to simulate a quantum computing device.

6. The quantum computing system of any of claims 1 to 4 wherein one or more of the units comprises a field programmable gate array, FPGA.

7. The quantum computing system of any preceding claim, wherein the quantum computing device is connected via a network and not collocated with the quantum processing unit, the quantum processing unit being configured to execute instructions to control the quantum computing device.

8. The quantum computing system of any preceding claim, further comprising a processor configured to execute computer program code to provide a user interface, the user interface being configured to provide an abstract representation of the modular architecture and being configured to receive user inputs to define or modify one or more selected from the set of:
number of units; type of a unit; configuration of a unit; connection to a unit's input interface; and, connections from a unit's output interface.

9. The quantum computing system of claim 8, further comprising a platform provisioning and linking the respective units in accordance with the abstract representation.

10. The quantum computing system of claim 8 or 9, further comprising a data repository defining architecture blocks, each architecture block comprising a plurality of pre-connected units, the user interface being configured to receive a user input selecting one of the architecture blocks and is configured to insert the pre-connected units corresponding to the architecture block into the abstract representation.

11. A quantum computing method comprising:
providing a plurality of units having types including a controller unit type, a quantum processing unit type and a classical processing unit type, each unit having an input interface and an output interface;
forming a quantum computing algorithm from instances of units having connections between selected ones of their respective input and output interfaces, each instance of a unit being of one of the unit types;
converting data received at an input of each quantum processing unit, executing a quantum computing device in accordance with the converted data, converting the output of the quantum computing device and outputting the converted output via the quantum processing units output interface;
in each classical processing unit, executing a stateless arithmetic function on inputs received at its input interface and outputting the function's output at its output interface;
executing the quantum computing algorithm by directing operation of the unit or units linked to the output interface of the or each unit having a controller unit type.

12. The method of claim 11, wherein the step of converting data includes transforming the data received via the quantum processing unit's input interface into instructions to manipulate the quantum computing device.

13. The method of claim 11 or 12, further comprising outputting the output of the or each classical processing unit to a display or data storage system.

14. The method of claim 11, 12 or 13, further comprising connecting each controller unit to a memory and saving at least a portion of the current state of the algorithm in the memory.

15. The method of any of claim 11, 12, 13 or 14, further comprising creating an instance of a unit by simulating it on a non-quantum computing device.

16. The method of any of claims 11 to 14, further comprising creating an instance of a unit by programming a field programmable gate array, FPGA.

17. The method of any of claims 11 to 16, further comprising providing a user interface providing an abstract representation of the algorithm including a representation of instances of the units and their connections and receiving user inputs to define or modify one or more selected from the set of:
number of units; type of a unit; configuration of a unit; connection to a unit's input interface; and, connections from a unit's output interface.

18. The method of claim 17, further comprising the step of executing a platform provisioning and linking the respective units in accordance with the abstract representation.

19. The method of claim 17 or 18, further comprising receiving, via the user interface, a user selection of an architecture block, retrieving from a data repository a definition of the selected architecture block, the definition including unit types and connections for a plurality of pre-connected units, and inserting the pre-connected units corresponding to the architecture block into the abstract representation.

20. A modular quantum computing system including:
a plurality of quantum processing units, each quantum processing unit including an input interface, an output interface and a data converter, the input interface being selectively connectable to other units of the quantum computing system and configured to pass data received at the input interface to the data converter and pass the output of the data converter to a quantum computing device, the output interface being selectively connectable to other units of the quantum computing system and configured to pass data received from the quantum computing device to the data converter and pass the output of the data converter to the output interface for communication to the unit or units connected to the output interface;
a plurality of classical processing units each classical processing unit including an input interface and an output interface and being configured to execute a stateless arithmetic function on inputs received at its input interface and is configured to output the function's output at its output interface, each classical processing unit being configured to be executed by a non-quantum computing device;
a controller unit connected to the input interface of one or more of the quantum processing units and/or one of the classical processing units and configured to execute control logic to direct operation of the unit or units connected thereto.

21. A computer program product, comprising a computer usable medium having a computer readable program code embodied therein for performing a quantum computing method, including:
computer readable program code configured to execute a plurality of quantum processing units, each quantum processing unit including an input interface, an output interface and a data converter, the input interface being selectively connectable to other units of the quantum computing system and configured to pass data received at the input interface to the data converter and pass the output of the data converter to a quantum computing device, the output interface being selectively connectable to other units of the quantum computing system and configured to pass data received from the quantum computing device to the data converter and pass the output of the data converter to the output interface for communication to the unit or units connected to the output interface;
computer readable program code configured to execute a plurality of classical processing units each classical processing unit including an input interface and an output interface and being configured to execute a stateless arithmetic function on inputs received at its input interface and is configured to output the function's output at its output interface, each classical processing unit being configured to be executed by a non-quantum computing device;
computer readable program code configured to execute a controller unit connected to the input interface of one or more of the quantum processing units and/or one of the classical processing units and configured to execute control logic to direct operation of the unit or units connected thereto.

22. A quantum computing method comprising:
receiving an algorithm definition, the algorithm definition comprising a plurality of classical processes and a plurality of quantum processes and defining a data flow therebetween;
generating a directed acyclic graph representation and associated control flow from the algorithm definition, whereby processes comprise nodes of the graph and data flow is defined by edges of the graph between nodes and the classical and quantum processes are stateless and executed independently and under the control of the control flow.

23. The quantum computing method of claim 22, further comprising:
instantiating classical and quantum processing resources to execute the classical and quantum processes;
passing data to the instantiated resources to execute in accordance with the control flow;
receiving output from the executed instantiated resource; and,
updating a stored state of the algorithm using the received output.

24. The quantum computing system of any of claims 1 to 10 comprising a variational quantum eigensolver, VQE, configured to determine the eigen energy of a molecule, the VQE comprising a controller unit, a quantum processing unit and a classical processing unit,
wherein the system is configured to receive a Hamiltonian of a given molecule and an ansatz as input parameters to the control unit,
the quantum processing unit and a classical processing unit being configured to execute in an iterative loop under control of the control unit,
the quantum processing unit being configured to receive the ansatz and Hamiltonian from the control unit, determine a plurality of expectation values of the ansatz for the Hamiltonian, each with different parameters and output to the classical processing unit;
the classical processing unit being configured to perform a gradient evaluation and value differences of the expectation values from the quantum processor and to determine and output the eigen energy of the given molecule.

25. The quantum computing system of claim 24, wherein the controller unit is configured to vary the ansatz for each iteration.

26. The quantum computing system of any of claims 1 to 10 comprising a quantum phase estimator, QPE, configured to determine the eigen energy of a molecule, the QPE comprising a controller unit, a quantum processing unit and a classical processing unit,
wherein the system is configured to receive a Hamiltonian of a given molecule, the control unit being configured to determine stopping criteria and trigger the quantum processing unit and the classical processing unit to run,
the quantum processing unit being configured to determine an encoded ground state energy from the Hamiltonian and to project the encoded ground state energy onto an ancillary qubit register and output to the classical processing unit until the stopping criteria are met; the classical processing unit being configured to perform a statistical estimate of the certainty of the output from the quantum processor, and to determine and output the eigen energy of the given molecule.

27. The quantum computing system of claim 24, 25 or 26, wherein each of the controller unit and the classical processing unit is defined in a portable, computer readable and executable, definition and is moveable from one underlying classical hardware processor to another transparently to execution of the VQE or QPE.

28. The quantum computing system of any of claims 24 to 27, wherein the quantum processing unit is defined in a portable, computer readable and executable, definition and moveable from one underlying quantum hardware processor to another transparently to execution of the VQE or QPE.

29. The quantum computing system of any of claims claim 24 to 28, wherein the quantum processing unit is defined in a portable, computer readable and executable, definition and moveable from a simulated quantum processor to a hardware quantum processor or from a hardware quantum processor to a simulated quantum processor transparently to execution of the VQE or QPE.
